(19) United States
(12) Patent Application Publication
(10) Pub. No.: US 2012/0175553 A1
(43) Pub. Date: Jul. 12, 2012

(54) METHOD FOR PRODUCING A SILICON INGOT

(76) Inventors: Andreas Krause, (US); Matthias Wagner, (US); Josef Stenzenberger, (US); Thomas Richter, (US); Gerd Fischer, (US); Mark Hollatz, (US); Silvio Stute, (US); Christian Kusterer, (US); Doreen Nauert, (US); Stefan Proske, (US)

(21) Appl. No.: 13/347,881

(22) Filed: Jan. 11, 2012

(30) Foreign Application Priority Data
Jan. 12, 2011 (DE) 10 2011 002 598.7

(51) Int. Cl. C09K 3/00; C01B 33/021; C03C 1/02

(52) U.S. Cl. 252/182.32; 65/33.9

(57) ABSTRACT

Method for producing a silicon ingot comprising the following steps: providing a container to receive a silicon melt, providing a temperature control device to control the temperature of the silicon melt in the container, arranging raw material in the container comprising silicon and at least one hydrogen-containing additive to reduce the formation of dislocations, and control of the temperature in the container (3) for the directed solidification of the silicon melt.

### CROSS-REFERENCES TO RELATED APPLICATIONS

This application claims the priority of German Patent Application, Serial No. 10 2011 002 598.7, filed Jan. 12, 2011, pursuant to 35 U.S.C. 119(a)-(d), the content of which is incorporated herein by reference in its entirety as if fully set forth herein.

### FIELD OF THE INVENTION

The invention relates to a method for producing a silicon ingot. The invention also relates to a silicon ingot. The invention furthermore relates to a crystalline silicon solar wafer.

### BACKGROUND OF THE INVENTION

A method for producing a silicon ingot is known from DE 10 2005 013 410 B4. As the crystal structure of a silicon ingot of this type has a substantial effect on the properties of the components subsequently produced therefrom, there is a continuous need to improve a method of this type.

It is known from EP 1 887 110 A1 that the addition of hydrogen gas to the gas phase reduces the formation of defects in the Czochralski method for producing monocrystalline silicon.

### SUMMARY OF THE INVENTION

The invention is therefore based on an object of improving a method for producing a silicon ingot.

This object is achieved a method for producing a silicon ingot comprising the steps of providing a container to receive a silicon melt, providing a temperature control device to control the temperature of the silicon melt in the container, arranging raw material in the container comprising silicon and at least one additive, wherein the additive comprises at least one hydrogen-containing compound, and controlling the temperature of the container in such a way that the raw material, during a specific method portion, is present in the container as a silicon melt, which is solidified in a directed manner during a subsequent method portion.

The core of the invention consists in adding an additive to a silicon melt to reduce the formation of recombination-active crystal defects. It was recognized according to the invention that this can be achieved in that a specific quantity of hydrogen is incorporated in the crystal lattice during the crystallization process. In particular, the defect density in the silicon ingot is reduced thereby. Moreover, free bonds in the silicon are saturated thereby.

The suppression of the formation of defects, in particular defect clusters, preferably takes place by adding a hydrogen-containing compound. Possible hydrogen-containing compounds here are, in particular, hydrogen, water or hydrocarbons, in particular methane or acetylene. The defect density in the silicon ingot can also be reduced by incorporating carbon in the crystal lattice. The incorporation of carbon and hydrogen complement one another advantageously here. The two elements lead to the saturation of free bonds in the silicon.

The total hydrogen content in the silicon melt is preferably in the range from 2 ppmw to 200 ppmw, in particular in the range from 10 ppmw to 100 ppmw, in particular in the range from 40 ppmw to 80 ppmw. This leads to the production of a silicon ingot that is particularly low in defects.

The additive preferably comprises at least one gaseous fraction. It may, in particular, be formed completely as a gas. This allows the additive to be added particularly easily to the silicon melt. The gas is mixed here by convection in the melt with the latter. A gaseous additive allows a particularly uniform distribution thereof in the melt.

The addition of the gaseous additive to a flushing gas allows the additive to be fed particularly easily to the silicon melt. It is provided, in particular, that an additive fraction of at most 25% by volume, in particular at most 10% by volume, but at least 1% by volume, in particular at least 5% by volume be mixed with the flushing gas.

According to the invention, the additive may also comprise a solid-bound fraction. It may, in particular, be present completely in solid-bound form. This already allows particularly easy metering of the additive before the melting of the silicon. Moreover, a targeted, locally varying arrangement of the additive in the melt crucible is made possible by this. It is, in particular, possible to arrange the additive with a concentration gradient in the melt crucible. The concentration of the additive in the region of the crucible base may be greater here than in a region remote from the base. The concentration of the additive may, in particular, decrease with an increasing distance from the crucible base.

It has proven to be particularly advantageous to use finely dispersed silicon powder as the additive. This preferably has a hydrogen content of at least 50 ppmw, in particular 200 ppmw. The hydrogen is present here, according to the invention, as a surface adsorbate.

To produce the additive, it is in particular provided that the finely dispersed silicon powder is to be exposed to a hydrogen-containing atmosphere. The hydrogen is absorbed here on the surface of the silicon powder.

Between the production of the additive and the feeding thereof to the container, there are preferably, at most 24 hours, in particular at most six hours, in particular at most one hour. The additive is preferably produced directly before feeding it to the container.

In order to achieve an adequately large hydrogen content, the adsorbing silicon powder has a surface of at least 1 m²/g, in particular at least 5 m²/g, in particular at least 10 m²/g. Powder of this type can also be mixed particularly well with silicon in the container.

It is possible to feed the additive as a powder, in other words finely dispersed, to the container. As an alternative to this, it is also possible to feed the additive to the container in the form of pressed molded bodies.

While the powder facilitates better mixing of the additive with the silicon in the container, the handling of the additive is facilitated by the configuration as a pressed molded body. Obviously, the additive can also be fed to the container partly as powder and partly in pressed form. It can, in particular, be fed to the container as a powder and in pressed form in equal parts.

The additive may also comprise at least one fraction of a substance, in particular a hydrocarbon, which is solid or liquid in normal conditions and passes into a gaseous state in the silicon melt. It may, in particular, be formed completely as a substance of this type. It is, in particular, possible for the additive to comprise at least one fraction of paraffin. Pure paraffin may also be provided as the additive.

It is provided according to the invention that the additive is to be fed at specific times or during special phases of the production method to the container. The additive can be fed to the container before the beginning of the solidification of the silicon melt, in particular before the melting of the silicon. The additive can also be fed to the container during the melting process. The additive can also be fed to the container after the beginning of the solidification of the silicon melt. It may, in particular, be advantageous to exclusively feed the additive to the container only after the beginning of the solidification of the silicon melt. For example, the additive may also only be fed to the container when a specific fraction of the silicon melt, in particular at least 10%, in particular at least 30%, in particular at least 50%, in particular at least 70%, has already solidified.

A further object of the invention is to provide a silicon wafer with improved properties.

This object is achieved a silicon wafer with a total wafer surface, comprising a dislocation density, which, over at most 10% of the total wafer surface, is greater than 2×10⁵ cm⁻², and a density of silicon carbide deposits, which is at most 3 dm⁻².

Further advantages, features and details of the invention emerge from the description of embodiments.

### BRIEF DESCRIPTION OF THE DRAWING

FIG. 1 shows a device for carrying out the method according to the invention.

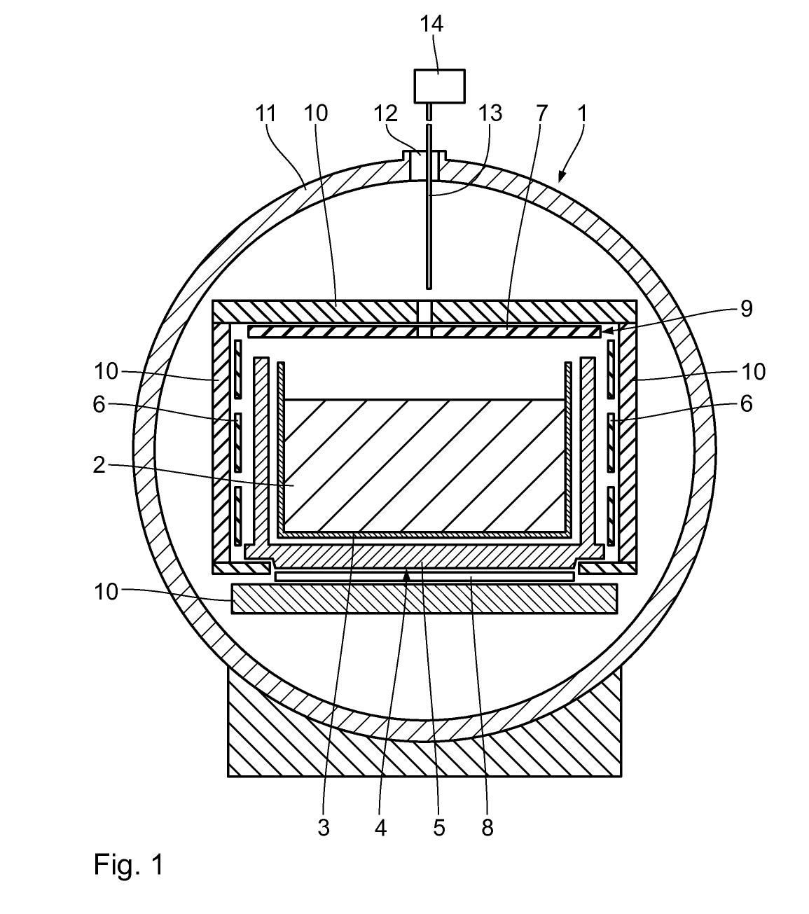

### DESCRIPTION OF THE PREFERRED EMBODIMENTS

A crystallization system 1 for crystallizing a silicon melt 2 comprises a container configured as a mould 3 to receive the silicon melt 2. The mould 3 is open at the top. It may have a rectangular, in particular a square cross section. It may also have a round, in particular a circular cross section. The mould 3 is surrounded by a support mould 4, which is also open at the top. The latter comprises a base plate 5, which is in turn carried by a frame, not shown in the figure. The mould 3 is laterally surrounded by side heating plates 6. A cover heating plate 7 is arranged above the mould 3. Moreover, a base heating plate 8 is provided below the mould 3.

In addition or as an alternative to the heating plates 6, 7 and 8, cooling elements may be provided laterally, above and below the mould 3.

The heating plates 6, 7 and 8 and/or the cooling elements are preferably controllable. The heating plates 6, 7 and 8 and the cooling elements together form a temperature control device 9 for the melting and/or directed solidification of the silicon in the mould 3. For details of the temperature control device 9, reference is made, for example, to DE 10 2005 013 410 B4.

The mould 3 may moreover be surrounded by a plurality of insulation elements.

The mould 3 is arranged in an outwardly closed crystallization chamber 11. The crystallization chamber 11 has a feedthrough 12 for a flushing pipe 13. By means of the flushing pipe 13, the crystallization chamber 11 can be acted upon by means of a flushing gas device 14 with flushing gas. Argon, in particular, is provided as the flushing gas. Alternatively, another inert protective gas can also be used. The atmosphere in the crystallization chamber 11 can, in particular, be controlled in a targeted manner by means of the flushing gas device 14.

The method according to the invention for producing a silicon ingot will be described below. Firstly, the crystallization system 1 is provided for melting and crystallizing the silicon melt 2 in the mould 3. In particular, the mould 3 is provided to receive the silicon melt 2 and the temperature control device 9 is provided to control the temperature of the silicon melt 2 in the mould 3. Raw material is then arranged in the mould 3. The raw material comprises silicon, in particular highly pure silicon. The silicon is, in particular, multi-crystalline silicon. The silicon of the raw material, in particular, has a degree of purity of at least 99%, in particular at least 99.99%, in particular at least 99.9999%.

To produce the silicon ingot, the temperature in the mould 3 is controlled by means of the temperature control device 9. The temperature in the mould 3 is, in particular, controlled in such a way that the raw material is present in the mould 3 during a specific method portion as a silicon melt 2, which is solidified in a directed manner during a subsequent method portion. For details of the directed solidification of the silicon melt 2, reference is made to DE 10 2005 013 410 B4.

The raw material, in particular the silicon, is fed to the mould 3 in solid form. It is melted in the mould 3. However, it is also possible to melt the raw material, in particular the silicon, before feeding it to the mould 3, and to feed it in liquid form to the mould 3.

Moreover, an additive to reduce the formation of dislocations in the silicon ingot is provided. The additive comprises at least one hydrogen-containing compound. This is, in particular, selected from the group of hydrogen, water and hydrocarbons, in particular methane or acetylene. The additive may also comprise a mixture of a plurality of hydrogen-containing compounds of this type.

According to a first embodiment of the invention, the additive is gaseous. In general, the additive comprises at least one gaseous fraction to reduce the formation of dislocations according to this embodiment.

It is fed to the silicon melt 2 by means of mixing it with a flushing gas, in other words fed by means of the flushing gas device 14. An additive fraction of at most 25% by volume, in particular at most 10% by volume, is mixed here with the flushing gas. The fraction of the additive in the flushing gas is, in particular, at least 1% by volume, in particular 5% by volume.

The additive has a hydrogen content such that the silicon melt 2 has a total hydrogen content, which is in the range of 2 ppmw to 200 ppmw, in particular in the range from 10 ppmw to 100 ppmw, in particular in the range from 40 ppmw to 80 ppmw. In particular, up to 2 mol hydrogen per 100 kg melt can be fed to the melt. In principle, a higher hydrogen feed is also possible.

According to this embodiment, a gas phase doping of the silicon melt 2 with hydrogen, in particular with a hydrocarbon, in particular methane or acetylene, is provided. As a result, it is possible to distribute the carbon very uniformly in the silicon melt 2 and therefore in the silicon ingot to be produced. It may, in particular, be ensured that the depositing limit for carbon in the silicon melt 2 is not exceeded.

The feeding of a hydrogen-containing additive simultaneously leads to a reduced oxygen load in the crystallization chamber 11, which leads to a lower content overall of dissolved oxygen in the silicon melt 2. This also has a positive effect on the quality of the silicon ingot to be produced.

A mixture of a hydrocarbon, in particular methane or acetylene, and pure hydrogen can also be added to the flushing gas. The fraction of the hydrocarbon is preferably at most 10% by volume of the flushing gas here. The fraction of the added hydrogen is at most 5% by volume of the flushing gas.

According to a further embodiment, it is provided that the additive comprises at least one solid-bound fraction, in particular is fed to the mould 3 in solid-bound form. It is provided here, in particular, that silicon powder, in particular finely dispersed silicon powder, with a hydrogen content of at least 50 ppmw, in particular at least 200 ppmw be used here as the additive.

The additive, in particular, comprises a hydrogen-containing silicon compound. The additive may, in particular, be selected from the group of HClSi(OR)₂, HₙSiCl₄₋ₙ, HSiCl₃, H₂SiCl₂, H₃SiCl and SiH₄. R stands for organic radical groups here, in particular alkoxy radicals. The additive may comprise one or more of these compounds. The additive may also consist of one or more of these compounds.

The fraction of the hydrogen-containing silicon powder used as the additive is in the range of 5% by weight to 40% by weight of the highly pure silicon in the mould 3. It is, in particular, in the range from 10% by weight to 30% by weight, in particular in the range from 20% by weight to 25% by weight.

To produce an additive of this type, it is provided according to the invention that the finely dispersed silicon powder is to be exposed to a hydrogen-containing atmosphere, so that an adsorption of the hydrogen takes place on the surface of the silicon powder. To produce the above-mentioned silicon compounds provided as an additive, in particular incomplete chemical reactions are provided during the silicon powder production, in particular during the depositing of monosilane as powder. These compounds enter the melt or the solid.

The adsorbing silicon powder preferably has a surface of at least 1 m²/g, in particular at least 5 m²/g, in particular at least 10 m²/g.

The additive may be fed to the container as powder or as a pressed molded body.

The production of the additive, in other words the hydrogen loading of the silicon powder, preferably takes place close in time, in particular at most 24 hours, in particular at most six hours, in particular at most one hour, in particular directly, before the arrangement of the additive in the mould 3.

It is possible, in particular, to arrange the additive with a spatially varying concentration in the mould 3. The concentration of the additive in a region close to the base of the mould 3 may be greater here than in a region which is further away from the base of the mould 3. The additive may, in particular, be arranged in the mould 3 in such a way that a gradient of the hydrogen content in the silicon melt 2 is formed, the hydrogen content in the silicon melt 2 reducing with an increasing distance from the base of the mould 3.

According to a further embodiment, the additive is solid or liquid under normal conditions and passes into a gaseous state in the silicon melt 2. The additive comprises at least one fraction of a substance of this type. The additive comprises, in particular, a fraction of a hydrocarbon compound of this type, in particular paraffin.

It may be provided in all the embodiments described above that the additive be fed to the container at a specific time, at specific times or during specific phases of the production method. It may, in particular, be provided that the additive is fed to the container before the beginning of the solidification of the silicon melt 2, in particular before the melting of the silicon melt in the container. The additive may also be fed to the container during the melting of the raw material. It may also be provided that the additive is to be fed to the container after the beginning of the solidification of the silicon melt 2. It may, in particular, be provided that the additive only be fed to the container if a specific fraction of the silicon melt 2, in particular at least 10%, in particular at least 30%, in particular at least 50%, in particular at least 70%, has already solidified.

The distribution of the additive, in particular the hydrogen concentration, in the silicon melt 2 can be influenced in a targeted manner by a targeted arrangement of the additive in the silicon melt 2. By targeted control of the convection of the silicon melt 2 in the mould 3 by means of the temperature control device 9, the distribution of the additive, in particular the hydrogen concentration, in the silicon melt 2 can be influenced in a targeted manner.

Obviously, the different embodiments can be combined with one another. It is, in particular, possible to provide a gas phase doping of the silicon melt 2 in addition to a solid-bound additive.

The silicon ingot produced by means of the method according to the invention has a length L and a multi-crystalline structure. It is, in particular, characterized in that over at least 90% of its length L on at most 10% of its cross sectional area, it has a dislocation density of more than 2×10⁵ cm ⁻². The grain density over the cross sectional areas is at least 200 dm⁻². The content of the substitutionally dissolved carbon is less than 2×10¹⁷ atoms/cm³. The density of silicon carbide deposits with a diameter of more than 1 μm over at least 90% of the length L of the ingot is at most 3 dm⁻².

Crystalline silicon solar wafers can be produced from the ingot. These are characterized by a dislocation density above 2×10⁵ cm⁻² in a surface fraction of at most 10% of the total wafer surface. The dislocation density, in other words, in a surface fraction of at least 90% of the total wafer surface, is at most 2×10⁵ cm⁻². The density of silicon carbide deposits with a diameter of more than 1 μm in these wafers is at most 3 dm⁻².

What is claimed is:

1. A method for producing a silicon ingot comprising the following steps:
providing a container (3) to receive a silicon melt (2),
providing a temperature control device (9) to control the temperature of the silicon melt (2) in the container (3),
arranging raw material in the container (3) comprising
silicon and
at least one additive, wherein the additive comprises at least one hydrogen-containing compound and
controlling the temperature of the container (3) in such a way that the raw material, during a specific method portion, is present in the container (3) as a silicon melt (2), which is solidified in a directed manner during a subsequent method portion.

2. A method according to claim 1, wherein the additive is selected from the group of hydrogen, water, methane, acetylene, HClSi(OR)₂, HₙSiCl₄₋ₙ, HSiCl₃, H₂SiCl₂, H₃SiCl and SiH₄, wherein R stands for an organic radical group.

3. A method according to claim 1, wherein the additive has a hydrogen content such that the silicon melt (2) has a total hydrogen content, which is in the range from 2 ppmw to 200 ppmw.

4. A method according to claim 1, wherein the additive has a hydrogen content such that the silicon melt (2) has a total hydrogen content, which is in the range from 10 ppmw to 100 ppmw.

5. A method according to claim 1, wherein the additive has a hydrogen content such that the silicon melt (2) has a total hydrogen content, which is in the range from 40 ppmw to 80 ppmw.

6. A method according to claim 1, wherein the additive comprises at least one gaseous fraction.

7. A method according to claim 6, wherein the gaseous fraction of the additive is fed to the silicon melt (2) by means of mixing it with a flushing gas.

8. A method according to claim 7, wherein the fraction of the additive in the flushing gas is at the most 25% by volume.

9. A method according to claim 7, wherein the fraction of the additive in the flushing gas is at the most 10% by volume.

10. A method according to claim 7, wherein the fraction of the additive in the flushing gas is at least 1% by volume.

11. A method according to claim 7, wherein the fraction of the additive in the flushing gas is at least 5% by volume.

12. A method according to claim 1, wherein the additive comprises at least one solid-bound fraction.

13. A method according to claim 12, wherein the additive comprises finely dispersed silicon powder.

14. A method according to claim 12, wherein the finely dispersed silicon powder has a hydrogen content of at least 50 ppmw.

15. A method according to claim 12, wherein the finely dispersed silicon powder has a hydrogen content of at least 200 ppmw.

16. A method according to claim 12, wherein to produce the additive, finely dispersed silicon powder is exposed to a hydrogen-containing atmosphere in such a way that an adsorption of the hydrogen takes place at the surface of the silicon powder.

17. A method according to claim 16, wherein the production of the additive takes place at most 24 h before the arrangement of the additive in the container.

18. A method according to claim 16, wherein the production of the additive takes place at most 6 h before the arrangement of the additive in the container.

19. A method according to claim 16, wherein the production of the additive takes place at most 1 h before the arrangement of the additive in the container.

20. A method according to claim 16, wherein the production of the additive takes place directly before the arrangement of the additive in the container.

21. A method according to claim 1, wherein the surface of the silicon powder provided as an additive is at least 1 m²/g.

22. A method according to claim 1, wherein the surface of the silicon powder provided as an additive is at least 5 m²/g.

23. A method according to claim 1, wherein the surface of the silicon powder provided as an additive is at least 10 m²/g.

24. A method according to claim 12, wherein the additive is fed as one of the group of a powder and a pressed molded body to the container (3).

25. A method according to claim 1, wherein the additive comprises at least one fraction, which, under normal conditions, is one of the group of solid and liquid and passes into a gaseous state in the silicon melt (2).

26. A method according to claim 1, wherein the additive is fed to the container (3) before the beginning of the solidification of the silicon melt (2).

27. A method according to claim 1, wherein the additive is fed to the container (3) after the beginning of the solidification of the silicon melt (2).

28. A silicon wafer with a total wafer surface, comprising
a. a dislocation density, which, over at most 10% of the total wafer surface, is greater than 2×10⁵ cm ⁻², and
b. a density of silicon carbide deposits, which is at most 3 dm⁻².
